(19) United States
(12) Patent Application Publication
(10) Pub. No.: US 2010/0033439 A1
(43) Pub. Date: Feb. 11, 2010

(54) SYSTEM AND METHOD FOR TOUCH SCREEN DISPLAY FIELD TEXT ENTRY

(76) Inventors: Marianne L. KODIMER, Huntington Beach, CA (US); William Su, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/435,424

(22) Filed: May 5, 2009

Related U.S. Application Data
(60) Provisional application No. 61/087,429, filed on Aug. 8, 2008.

(51) Int. Cl. G06F 3/041

(52) U.S. Cl. 345/173

(57) ABSTRACT

The subject application is directed to a system and method for touch screen display field text entry. Keyboard indicia is generated on a touch screen interface after contact with a first touch-sensitive text entry field of at least one touch-sensitive text entry displayed on an associated display, the keyboard indicia including indicium corresponding to each of plurality of touch-sensitive character areas. Text entry is generated in the first text entry field corresponding to contact with each indicium and the first text entry field is highlighted on the display as an active text entry field after contact therewith.

### CROSS-REFERENCE TO RELATED APPLICATIONS

This application claims priority to U.S. Provisional Patent Application Ser. No. 61/087,429, titled “SYSTEM AND METHOD FOR RECEIVING USER INPUT VIA A TOUCH SCREEN INTERFACE OF AN ASSOCIATED DOCUMENT PROCESSING DEVICE”, filed on Aug. 8, 2008.

### BACKGROUND OF THE INVENTION

The subject application is directed generally to entry of text into text fields of a touch screen display. The application is particularly applicable to improved text entry in control interfaces of document processing devices.

Touch screens are popular devices used in conjunction with a myriad of user interfaces on computers, appliances, kiosks, and the like. A touch screen provides an intuitive interface wherein input to control many features can be easily programmed or altered as needed.

Touch screen interfaces are frequently used on document processing devices, such as copiers, printers, e-mail systems, facsimile machines or scanners, as well as on devices having two or more of these functions. Such devices are commonly referred to as multifunction peripherals (MFPs) or multifunction devices (MFDs).

Often it is desirable to input text strings into a touch screen display. While some displays may include associated programming so as to allow for understanding of handwritten characters, it is often more desirable to generate a “soft keyboard” on the touch screen display. Such a soft keyboard suitably appears as a computer keyboard, and contact with indicia corresponding to a character generates a text input correspondingly.

On document processing devices, there is often more than one text field that requires input for device operation. Such text fields include data entry for items such as username, password, telephone number, accounting codes, addresses, including e-mail addresses and strings for document customization.

### SUMMARY OF THE INVENTION

In accordance with one embodiment of the subject application, there is provided a system and method for touch screen display field text entry. A keyboard indicia is generated on a touch screen interface after contact with a first touch-sensitive text entry field of at least one touch-sensitive text entry displayed on an associated display, the keyboard indicia including indicium corresponding to each of plurality of touch-sensitive character areas. Text entry is generated in the first text entry field corresponding to contact with each indicium and the first text entry field is highlighted on the display as an active text entry field after contact therewith.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for touch screen display field text entry according to one embodiment of the subject application;

FIG. 2 is a block diagram illustrating device hardware for use in the system for touch screen display field text entry according to one embodiment of the subject application;

FIG. 3 is a functional diagram illustrating the device for use in the system for touch screen display field text entry according to one embodiment of the subject application;

FIG. 4 is a block diagram illustrating controller hardware for use in the system for touch screen display field text entry according to one embodiment of the subject application;

FIG. 5 is a functional diagram illustrating the controller for use in the system for touch screen display field text entry according to one embodiment of the subject application;

FIG. 6 is a functional diagram illustrating a workstation for use in the system for touch screen display field text entry according to one embodiment of the subject application;

FIG. 7 is a block diagram illustrating the system for touch screen display field text entry according to one embodiment of the subject application;

FIG. 8 is a functional diagram illustrating the system for touch screen display field text entry according to one embodiment of the subject application;

FIG. 9 is a flowchart illustrating a method for touch screen display field text entry according to one embodiment of the subject application;

FIG. 10 is a flowchart illustrating a method for touch screen display field text entry according to one embodiment of the subject application;

FIG. 11 is an example illustration of a touch screen user interface for use in the system and method for touch screen display field text entry according to one embodiment of the subject application;

FIG. 12 is an example illustration of a soft keyboard for use in the system and method for touch screen display field text entry according to one embodiment of the subject application;

FIG. 13 is an example illustrating a soft keyboard and modified text entry field for use in the system and method for touch screen display field text entry according to one embodiment of the subject application; and

FIG. 14 is an example illustrating a touch screen user interface for use in the system and method for touch screen display field text entry according to one embodiment of the subject application.

### DETAILED DESCRIPTION OF THE PREFERRED EMBODIMENT

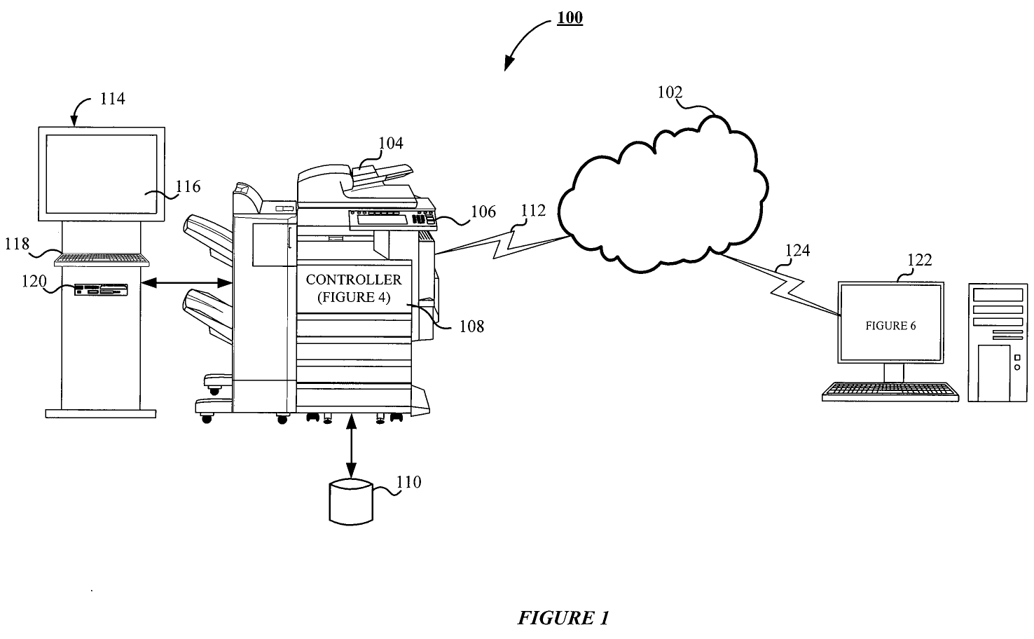

The subject application is directed to a system and method for receiving text input into text fields of a touch screen display. In particular, the subject application is directed to a system and method for improved text entry in control interfaces of document processing devices. More particularly, the subject application is directed to a system and method that is applicable to receipt of text input for operation of document processing devices via a text field generated via an associated touch screen interface. It will become apparent to those skilled in the art that the system and method described herein are suitably adapted to a plurality of varying electronic fields employing touch screen interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for touch screen display field text entry in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

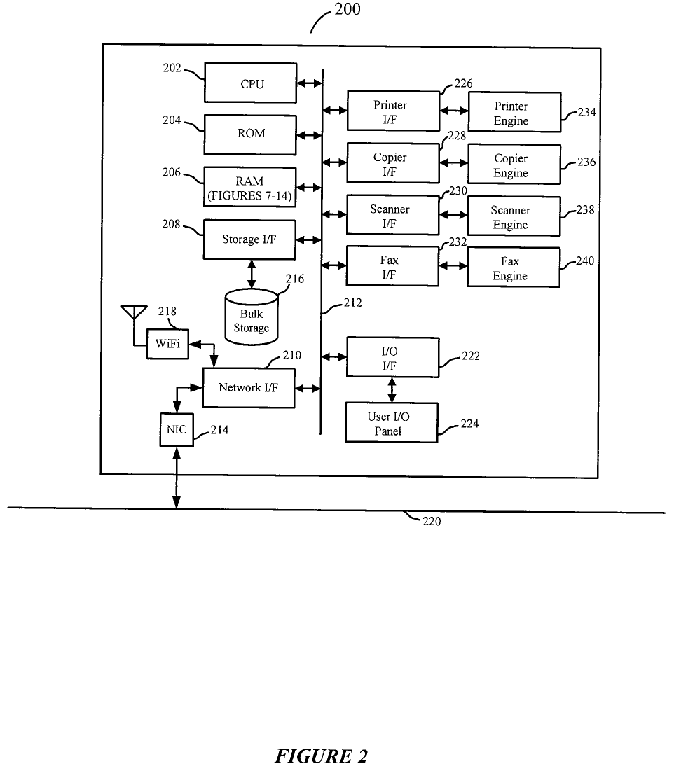

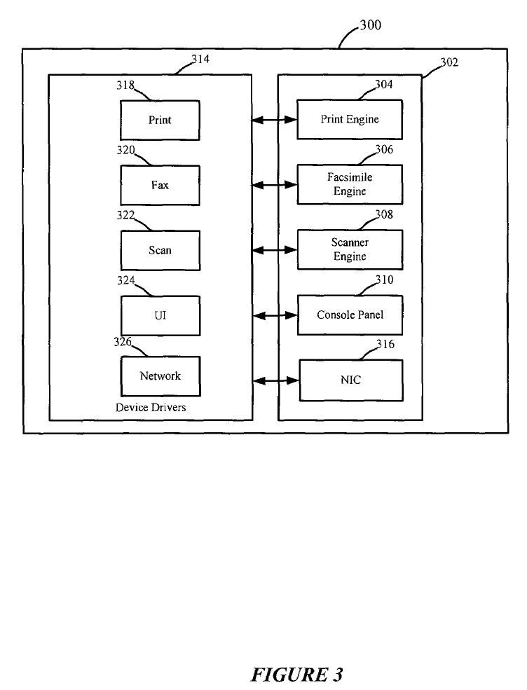

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, thin client interfaces, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

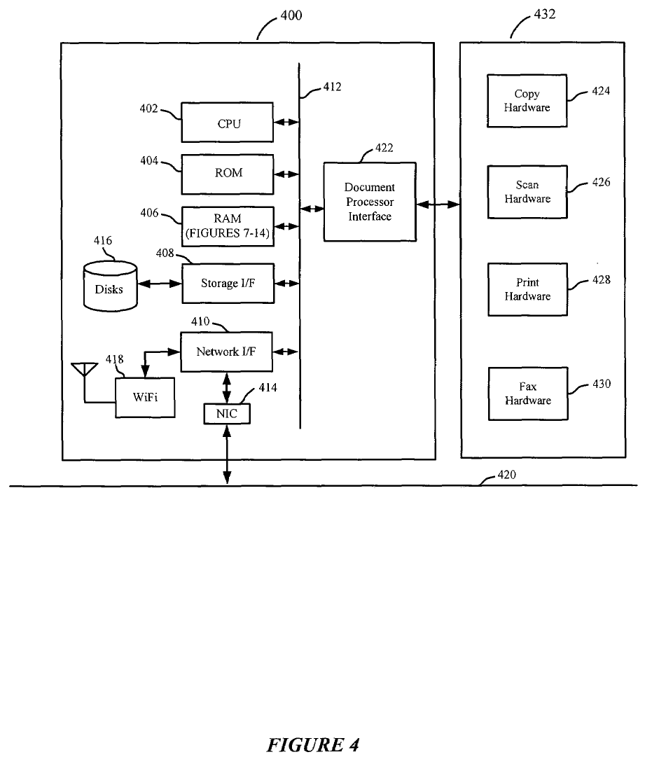

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the touch screen display field text entry system and method of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, display a thin client interface, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a user device 122, illustrated a computer workstation in data communication with the computer network 102 via a communications link 124. It will be appreciated by those skilled in the art that the user device 122 is shown in FIG. 1 as a computer workstation for illustration purposes only. As will be understood by those skilled in the art, the computer workstation 122 is representative of any personal computing device known in the art including, for example and without limitation, a laptop computer, a workstation computer, a personal data assistant, a web-enabled cellular telephone, a smart phone, a proprietary network device, or other web-enabled electronic device. Preferably, the user device 122 incorporates a touch screen display, suitably configured to display and receive user input via tactile interaction with the display, as will be understood by those skilled in the art. According to one embodiment of the subject application, the user device 122 includes a suitable thin client interface, such as a web browser, via which an associated user is capable of interacting with the document processing device 104 via the computer network 102. It will be understood by those skilled in the art that the user device 122 is capable of employing a dedicated application resident thereon and configured to interact with the document processing device 104 via the touch screen display. In such embodiments, the user device 122 is capable of implementing a soft keyboard via an associated touch screen interface.

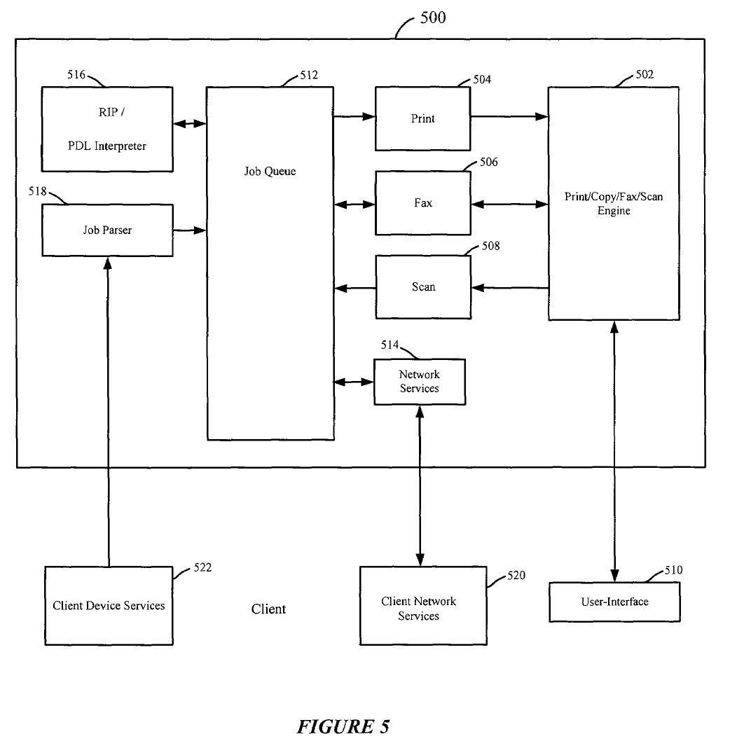

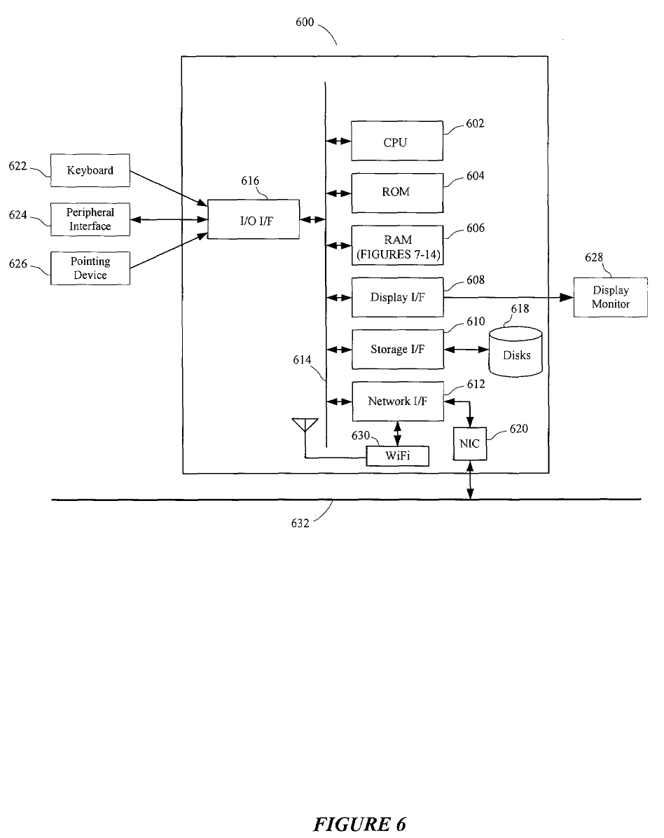

The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In accordance with one embodiment of the subject application, the computer workstation 122 is suitably configured to perform color space conversions according to the systems and methods set forth in the subject application. The functioning of the computer workstation 122 will better be understood in conjunction with the diagram illustrated in FIG. 6, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212. 0 Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the user device 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

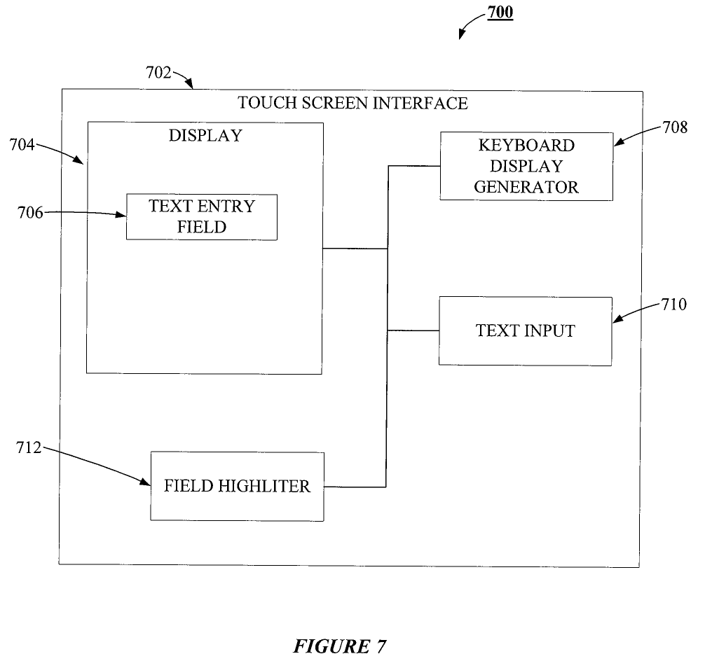

Referring now to FIG. 7, illustrated is a block diagram of a system 700 for touch screen display field text entry in accordance with one embodiment of the subject application. As shown in FIG. 7, the system 700 incorporates a touch screen interface 702 that includes a display 704 having one or more touch-sensitive text entry fields 706. The system 700 further includes a keyboard display generator 708 that is configured to generate keyboard indicia on the touch screen interface 702 following contact with the first of the touch-sensitive text entry fields 706. Preferably, the keyboard indicia includes indicium corresponding to each of a plurality of touch-sensitive character areas.

The system 700 also includes a text input 710 configured for generation of text entry in the first text entry field 706 corresponding to contact with each indicium on the display 704. A field highlighter 712 is then employed by the system 700 and operative for highlighting the first text entry field 706 as an active text entry field after contact therewith.

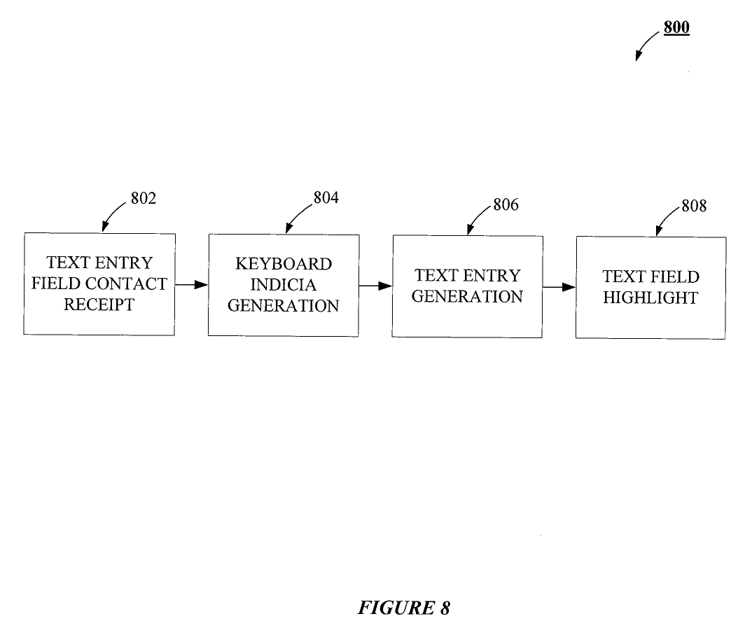

Turning now to FIG. 8, illustrated is a functional diagram of a system 800 for touch screen display field text entry in accordance with one embodiment of the subject application. As shown in FIG. 8, text entry field contact receipt 802 first occurs corresponding to a contact with a first touch-sensitive text entry field of at least one touch-sensitive text entry displayed on an associated display. Keyboard indicia generation 804 is then performed corresponding to the generation of keyboard indicia on a touch screen interface after contact receipt 802. Preferably, the keyboard indicia includes indicium corresponding to each of plurality of touch-sensitive character areas. Text entry generation 806 is then performed corresponding to the generation of text in the first text entry field corresponding to contact with each indicium. Thereafter, text field highlight 808 is performed of the first text entry field on the display as an active text entry field after contact therewith.

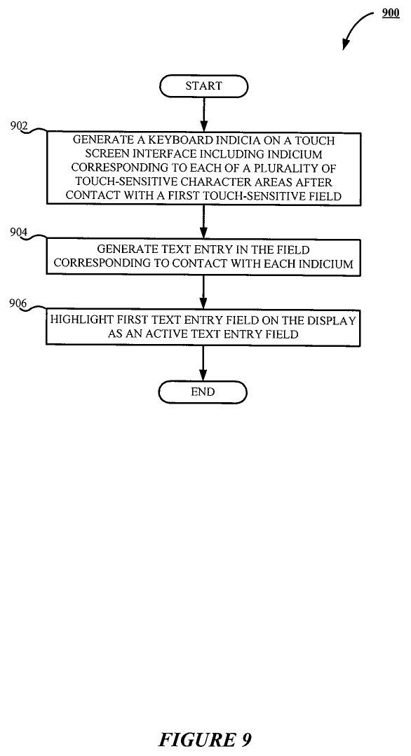

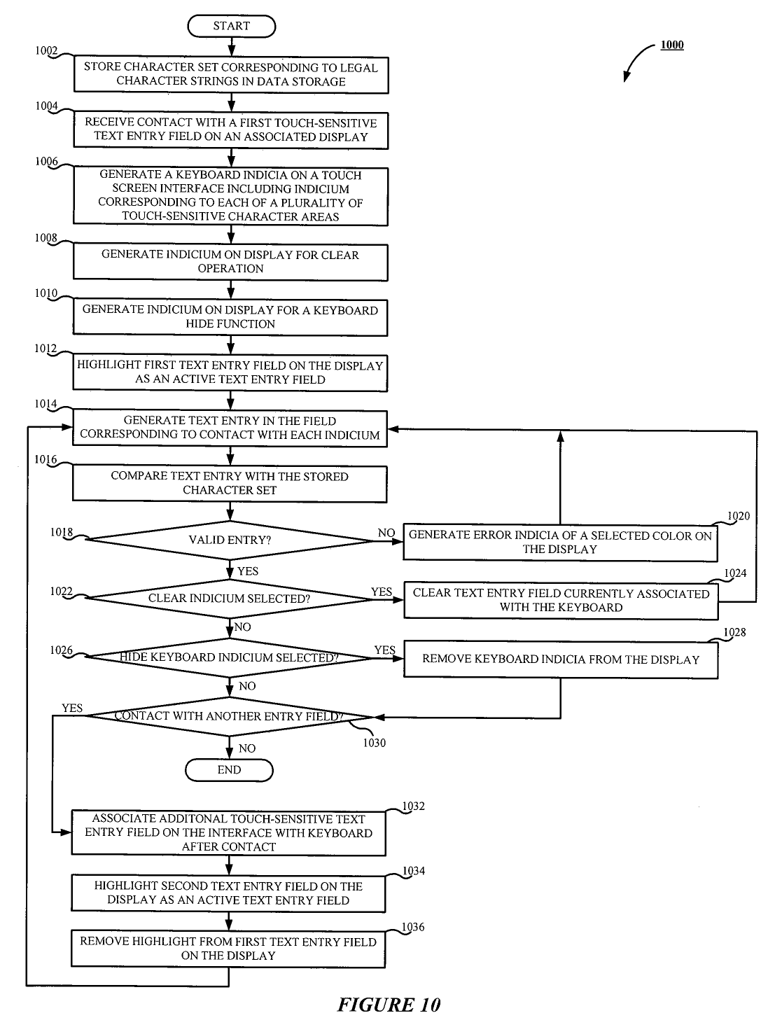

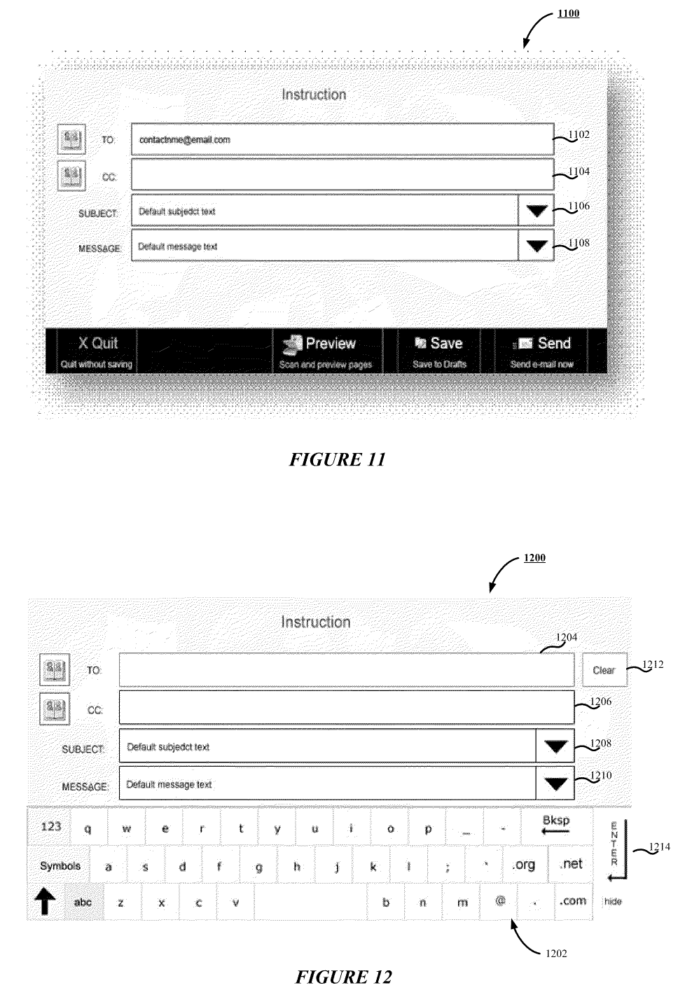

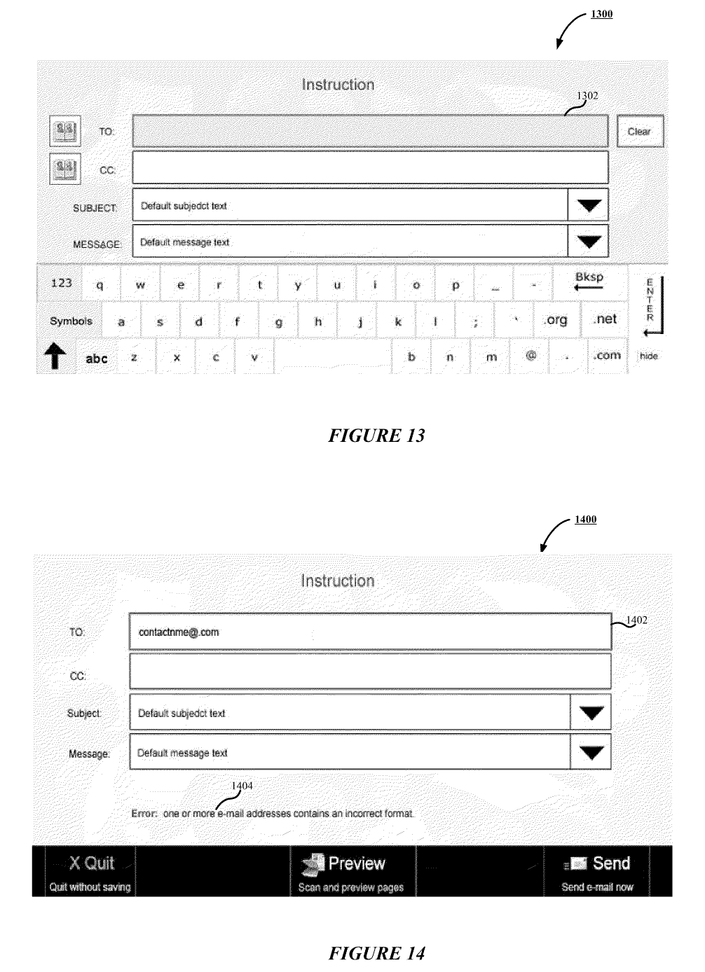

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example illustrations of FIG. 11, FIG. 12, FIG. 13, and FIG. 14. Turning now to FIG. 9, there is shown a flowchart 900 illustrating a method for touch screen display field text entry in accordance with one embodiment of the subject application. Beginning at step 902, a keyboard indicia is generated on a touch screen interface after contact with a first touch-sensitive text entry field of at least one touch-sensitive text entry displayed on an associated display. According to one embodiment of the subject application, the keyboard indicia include indicium corresponding to each of plurality of touch-sensitive character areas. At step 904, text entry is then generated in the first text entry field corresponding to contact with each indicium. Thereafter, at step 906, the first text entry field is highlighted on the display as an active text entry field after contact therewith.

Referring now to FIG. 10, there is depicted a flowchart 1000 illustrating a method for touch screen display field text entry in accordance with one example embodiment of the subject application. The methodology of FIG. 10 begins at step 1002, whereupon at least one character set corresponding to legal character strings is stored in the data storage device 110 associated with the document processing device 104. Suitable legal character sets include, for example and without limitation, a numeric set for input of a facsimile number, an alpha-numeric set inclusive of an ampersand character for an electronic mail address, a numeric set for input of an account number, and the like. According to one embodiment of the subject application, the legal character sets include proper formatting associated with a selected text entry field, e.g. a property telephone number format, a proper electronic mail address format, a proper account number format, and the like.

It will be appreciated by those skilled in the art that the user device 122 or other suitable component coupled to the computer network 102 is also capable of storing the character sets when such device 122 is equipped with a touch screen interface and employs a thin client operative thereon configured to communicate with the document processing device 104 via the established computer network 102. Those skilled in the art will appreciate that suitable thin clients include, for example and without limitation, a web browser, a dedicated interface application, or any other suitable hardware, software, or combination thereof capable of facilitating the operation of a thin client interface and generation of soft keyboard in accordance with one embodiment of the subject application. For purposes of example only, reference is now made hereinafter to the user device 106 or kiosk touch screen display 116 with respect to FIGS. 10-14. The skilled artisan will appreciate that other suitable touch-sensitive devices are also capable of implementing the methodology of FIG. 10, and the subject application is not limited to the user interface 106 or display 116.

At step 1004, contact with a first touch-sensitive text entry field is received on the display 106 or 116 associated with the document processing device 104. FIG. 11 illustrates a suitable a template user interface screen 1100 illustrating a tactile user interface displayed via the user interface 106 or display 116 associated with the document processing device 104 in accordance with one embodiment of the subject application. As shown in FIG. 11, the interface 1100 includes a plurality of text fields 1102, 1104, 1106, and 1108, each of which is selectable by the associated user via tactile input thereon, i.e. the contact received at step 1004.

Keyboard indicia is then generated on the touch screen interface (user interface 106 or display 116) at step 1006. In accordance with one embodiment of the subject application, the keyboard indicia includes indicium corresponding to each of a plurality of touch-sensitive character areas, e.g. selectable character icons associated with the selected text entry field. FIG. 12 illustrates a suitable a template user interface screen 1200 illustrating the keyboard indicia 1202 generated on the touch screen capable user interface 106 or display 116 associated with the document processing device 104 in accordance with one embodiment of the subject application. As shown in FIG. 12, the user interface screen 1200 includes keyboard indicia 1202 representative of a soft keyboard for selection of characters by an associated user, a plurality of text entry fields 1204, 1206, 1208, and 1210. As the skilled artisan will appreciate, a soft keyboard comprises a graphical representation of a keypad of alphanumeric characters on a touch screen display, which keypad is capable of implementation in a standard QWERTY layout of characters, an ABCDEF layout of characters, or the like.

At step 1008, indicium is generated on the user interface 106 or display 116 corresponding to a clear operation. Suitable indicium is illustrated in FIG. 12 as the clear key 1212 of the interface screen 1200. A keyboard hide indicium is then generated on the interface screen 1200 at step 1010 corresponding to a hiding of the keyboard function. Suitable indicium representing such a function is illustrated in FIG. 12 as the hide key 1216. At step 1012, a first text entry field is highlighted on the user interface 106 or display 116 as an active text entry field, i.e. the field in which selected characters are placed. FIG. 13 illustrates an interface screen 1300 wherein highlighting of the selected field 1302 is depicted in accordance with step 1012. FIG. 12 also illustrates a form of highlighting the selected text field 1204 as indicated by the outline thereof that differs in color from the remaining fields.

Text entry is then generated in the active field corresponding to contact with each indicium at step 1014. That is, characters are inserted into the selected field 1204 upon selection of a key from the indicium 1202 by the associated user. The text entry in the field 1204 is then compared at step 1016 with a stored character set associated with the text entry field 1204. FIG. 14 illustrates a template screen 1400 in which characters are inserted into a text entry field 1402, in this case an electronic mail address field. A determination is then made at step 1018 whether the text entry in the entry field 1402 is a valid entry based upon the comparison performed at step 1016. Upon a negative determination, flow proceeds to step 1020, whereupon an error indicia is generated on the user interface 106 or display 116 of a selected color indicating the error. That is, upon a determination that the area code is missing from a facsimile number, an electronic mail address is missing part of an address, an account number is short one or more digits, or the like, an error has occurred. FIG. 14 depicts such an error via the change in color outline of the selected field 1402 and the display of an error message 1404. Operations then return to step 1014 for entry of suitable text in the selected text entry field.

Upon a determination at step 1018 that the entry is valid, flow proceeds to step 1022, whereupon a determination is made whether the clear indicium has been selected. That is, whether the clear key 1212 generated at step 1008 has been selected. When the clear key 1212 has been selected via tactile input by the associated user, flow proceeds to step 1024, whereupon the active text entry field currently associated with the displayed keyboard 1202 is cleared of input text. Flow with respect to FIG. 10 then returns to step 1014 for entry of text by the associated user in the selected text entry field. Following a determination at step 1022 that the clear indicium was not selected, flow progresses to step 1026. At step 1026, a determination is made whether the hide keyboard indicium, e.g. the hide key 1216, has been selected by the associated user. Upon selection of the hide key 1216 by the associated user, operations proceed to step 1028, whereupon the keyboard indicia 1202 is removed from the screen 1200 of the user interface 106 or display 116.

After hiding of the keyboard indicia 1202, or upon a negative determination at step 1026, flow proceeds to step 1030. At step 1030, a determination is made whether contact has been made with another entry field, e.g. the text entry field 1206 of FIG. 12. If no additional text entry field is selected by the user, operations with respect to FIG. 10 terminate. That is, the document processing device 104 performs a selected operation in accordance with the information provided via the operations of FIG. 10. When it is determined at step 1030 that another text entry field 1206 has been selected, flow proceeds to step 1032. At step 1032, the additional touch-sensitive text entry field 1206 is associated with the keyboard indicia 1202 after the selection of the field 1206, i.e. after contact with the field 1206. At step 1034, the second text entry field 1206 is highlighted on the user interface 106 or display 116 as the active text entry field. The highlight from the first text entry field 1204 is then removed at step 1036. Flow then returns to step 1014, whereupon text entry is generated in the text entry field 1206 corresponding to contact with characters of the keyboard indicia 1202 and operations continue thereafter as set forth above.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A touch screen display field text entry system comprising:
a touch screen interface including a display having at least one touch-sensitive text entry field;
a keyboard display generator operative to generate keyboard indicia on the touch screen interface after contact with a first touch-sensitive text entry field of the at least one thereof, the keyboard indicia including indicium corresponding to each of a plurality of touch-sensitive character areas;
a text input operative to generate text entry in the first text entry field corresponding to contact with each indicium; and
a field highlighter operable to highlight the first text entry field as an active text entry field after contact therewith.

2. The system of claim 1 further comprising:
at least a second touch-sensitive text entry field on the touch screen interface, wherein the keyboard indicia is associated with the second touch-sensitive text entry field after contact therewith; and
wherein the field highlighter is further operable, after contact with the second text entry field, to highlight the second text entry field and remove highlighting of the first text entry field.

3. The system of claim 2 further comprising:
a data storage storing at least one character set corresponding to legal character strings;
a comparator operable to compare text entry with the at least one character set; and
the display including an error indicia corresponding to an output of the comparator.

4. The system of claim 3 wherein the error indicia is comprised of a selected color corresponding to a highlight of a text entry field associated therewith.

5. The system of claim 4 wherein the keyboard includes an indicium corresponding to a clear operation wherein a text entry field currently associated with the keyboard is erased upon contact therewith.

6. The system of claim 5 wherein the display further includes an indicium corresponding to a keyboard hide function wherein the keyboard indicia is removed from the display after contact therewith.

7. A method for touch screen display field text entry comprising the steps of:
generating a keyboard indicia on a touch screen interface after contact with a first touch-sensitive text entry field of at least one touch-sensitive text entry displayed on an associated display, the keyboard indicia including indicium corresponding to each of plurality of touch-sensitive character areas;
generating text entry in the first text entry field corresponding to contact with each indicium; and
highlighting the first text entry field on the display as an active text entry field after contact therewith.

8. The method of claim 7 further comprising the steps of:
associating at least a second touch-sensitive text entry field on the touch screen interface with the keyboard indicia after contact therewith; and
highlighting the second text entry field and removing highlighting from the first text entry field in accordance with an contact with the second text entry field.

9. The method of claim 8 further comprising the steps of:
storing at least one character set corresponding to legal character strings in an associated data storage;
comparing text entry with the at least one character set; and
generating an error indicia on the display corresponding to an output of the comparison.

10. The method of claim 9 wherein the error indicia is comprised of a selected color corresponding to a highlight of a text entry field associated therewith.

11. The method of claim 10 further comprising generating an indicium on the display corresponding to a clear operation and clearing a text entry field currently associated with the keyboard upon contact therewith.

12. The method of claim 11 further comprising generating an indicium on the display corresponding to a keyboard hide function, and removing the keyboard indicia from the display after contact therewith.

13. A touch screen display field text entry system comprising:
a touch screen interface including a display having at least one touch-sensitive text entry field;
a display generator means adapted for generating a keyboard indicia on the touch screen interface after contact with a first touch-sensitive text entry field of the at least one thereof, the keyboard indicia including indicium corresponding to each of plurality of touch-sensitive character areas;
a text input means adapted for generating text entry in the first text entry field corresponding to contact with each indicium; and
means adapted for highlighting the first text entry field on the display as an active text entry field after contact therewith.

14. The system of claim 13 further comprising:
at least a second touch-sensitive text entry field on the touch screen interface, wherein the keyboard indicia is associated with the second touch-sensitive text entry field after contact therewith; and
the field highlight means further including means adapted for highlighting the second text entry field and means adapted for removing highlighting from the first text entry field in accordance with an contact with the second text entry field.

15. The system of claim 14 further comprising:
a data storage means adapted for storing at least one character set corresponding to legal character strings;
a comparison means adapted for comparing text entry with the at least one character set; and
means adapted for generating an error indicia on the display corresponding to an output of the comparison means.

16. The system of claim 15 wherein the error indicia is comprised of a selected color corresponding to a highlight of a text entry field associated therewith.

17. The system of claim 16 wherein the keyboard includes an indicium corresponding to a clear operation and further comprising means adapted for clearing a text entry field currently associated with the keyboard upon contact therewith.

18. The system of claim 17 wherein the display further comprising means adapted for generating an indicium on the display corresponding to a keyboard hide function, and means adapted for removing the keyboard indicia from the display after contact therewith.
